(19) United States
(12) Patent Application Publication
(10) Pub. No.: US 2017/0161425 A1
(43) Pub. Date: Jun. 8, 2017

(54) COMPACT MODELING ANALYSIS OF CIRCUIT LAYOUT SHAPE SECTIONS

(71) Applicant: INTERNATIONAL BUSINESS MACHINES CORPORATION, Armonk, NY (US)

(72) Inventors: Mitchell R. DeHond, Essex Junction, VT (US); Ulrich A. Finkler, Mahopac, NY (US); Harold E. Reindel, Williston, VT (US); Steven E. Washburn, Poughquag, NY (US); Richard Q. Williams, Essex Junction, VT (US)

(21) Appl. No.: 14/957,700

(22) Filed: Dec. 3, 2015

(51) Int. Cl. G06F 17/50

(52) U.S. Cl. CPC G06F 17/5081; G06F 17/5036

(57) ABSTRACT

Methodologies for compact modeling of circuit layouts to accurately account for effects of layout-induced changes in semiconductor devices induced by various intentional and unintentional mechanisms present in semiconductor processes are disclosed. The layout-sensitive compact model accounts for the impact of large layout variation on circuits by implementing techniques for obtaining the correct layout-dependent response approximations and by incorporating layout extraction techniques to obtain correct geometric parameters that drive the LDE response. In particular, these techniques include utilizing shape sections for analyzing in detail various specific region shapes of the semiconductor device. The shape sections are defined by locating vertices of each region shape and rendering reference lines at each vertex. The shape section definitions are utilized in the compact model to determine device model quantities, such as induced LDE effects upon a transistor from the region, at a finer granularity to provide for more accurate simulations.

### FIELD OF THE INVENTION

Embodiments of the invention relate to a technique for determining simulated transistor model quantities, such as device mobility quantities, work function quantities, series resistance quantities, saturation velocity quantities, etc. for semiconductor devices and, more particularly to a technique for determining how these quantities are affected by the particular layout of a semiconductor device.

### DESCRIPTION OF THE RELATED ART

Integrated circuit designers worry about physical layout of features of the integrated circuit. However as geometries of integrated circuits have shrunk, a new type of variability has been recognized, collectively known as layout-dependent effects (LDEs). Three major sources of LDEs are well proximity, length of oxide diffusion, and oxide-to-oxide spacing which affect the threshold voltage and mobility.

Some factors that influence LDEs include the spacing between a field effect transistor (FET) gate and adjacent structures, the dimensions and perimeter geometry of these adjacent structures, the amount of contact coverage (or source/drain strapping), etc. Small changes in FET layout can introduce noticeable shifts in drive current, and this variation can appear to change device to device across an integrated circuit chip. Not accounting for this magnitude of variation of LDEs can seriously underpredict or overpredict electrical performance in circuit simulation. Furthermore, with information about the influence of LDEs on a given layout, circuit designers can optimize their circuit designs.

Some previously developed LDEs that have been studied include shallow trench isolation (STI) stress effects and N-Well scattering effects. The STI stress effect is accounted for by obtaining the length and width of the active area (silicon island surrounded by STI) of the semiconductor device and adjusting the mobility as a function of these two parameters. The primary cause of stress in the STI process is that a compressive stress is typically applied in both longitudinal (orthogonal to the gate width) and transverse (parallel to the gate width) directions, altering the silicon band structure locally. Such a stress degrades the NFETs while benefiting the PFET. The stress-based adjustment is then based purely on empirical or Technology Computer Aided Design (TCAD) simulation data from a set of specifically designed macros that span the complete length/width active area parameter space. Then for any given active area length/width, one can interpolate the results. Moreover, parametric fits to the mobility impact can be experimentally obtained from experimental data.

The N-well scattering effect occurs when implant dopant ions scatter off the sidewalls of relatively thick resist layers to unintended locations. N-well implant scattering is therefore also layout sensitive, but this sensitivity is unrelated to stress effects. That is, the influence of N-well implant scattering alters the voltage threshold (Vt) of devices that happen to be close by. This impact causes circuit operability problems and therefore must be properly accounted for. The modeling methodology is to identify the N-well resist proximity based on plan view layout and defining, again through empirical or TCAD simulation calibration or experimental data, and based on distances from this N-well resist, the threshold voltage impact of the N-well scattering.

Recently process technology has been introduced that deliberately introduces favorable stress into the semiconductor device in a way that increases the performance of the semiconductor device. Examples of this process technology include contact etch stop liner films with high levels of compressive or tensile stress and materials like silicon germanium or silicon carbide which are added to MOSFET source and drain regions to directly add favorable channel strain. While these methods generally improve transistor performance, their effectiveness is dependent on the types of adjacent shapes (i.e., the circuit layout) and therefore these process technologies are additional sources of layout-dependent effects. As before, these LDE's can be modeled using empirical or computer simulation calibration or experimental data as well as various circuit layout measurements. It would be highly desirable to provide a system and method that extends the above concepts to accurately account for layout-induced changes in semiconductor devices.

### SUMMARY

In an embodiment of the present invention, a method of compact modeling of a semiconductor device includes analyzing a circuit layout to determine a shape of a region that causes layout depended effects upon the semiconductor device, defining shape sections within the shape, determining layout dependent effects caused by each shape section upon the semiconductor device, and modeling semiconductor device performance based upon the layout dependent effects caused by each shape section.

In another embodiment of the present invention a computer program product for modeling a semiconductor device includes a computer readable storage medium having program instructions embodied therewith that are readable by a processor to cause the processor to analyze a circuit layout to determine a shape of a region that causes layout dependent effects upon the semiconductor device, define shape sections within the shape, determine layout dependent effects caused by each shape section upon the semiconductor device, and model semiconductor device performance based upon the layout dependent effects caused by each shape section.

In yet another embodiment of the present invention, a method for optimizing semiconductor transistor performance includes receiving a circuit layout comprising a semiconductor device and a region that causes layout dependent effects upon the semiconductor device, analyzing the circuit layout to determine a shape of the region that causes layout dependent effects upon the semiconductor device and a shape of the semiconductor device, locating vertices of the semiconductor device shape and vertices of the region that causes layout dependent effects, defining sections of the shape of the region that causes layout dependent effects by rendering reference lines at the vertices of the semiconductor device shape and rendering reference lines at the vertices of the shape of the region that causes layout dependent effects, determining layout dependent effects caused by each shape section upon the semiconductor device, simulating semiconductor device performance based upon the layout dependent effects caused by each shape section, and modifying the circuit layout if the semiconductor device does not exceed a predetermined performance threshold.

These and other embodiments, features, aspects, and advantages will become better understood with reference to the following description, appended claims, and accompanying drawings.

### BRIEF DESCRIPTION OF THE DRAWINGS

FIG. 1 illustrates an example of a semiconductor device that may be simulated to determine transistor model quantities and illustrates how the layout of the semiconductor device affects the transistor model quantities.

FIG. 2 illustrates an example of a semiconductor device that may be simulated to determine transistor model quantities and illustrates how the layout of the semiconductor device affects the complexity of the simulation.

FIG. 3 and FIG. 4 illustrate semiconductor device LDE-enabled compact model stages, according to embodiments of the invention.

FIG. 5A and FIG. 5B illustrate embodiments for calculating simulated semiconductor device transistor model quantities, according to embodiments of the invention.

FIG. 6 illustrates an exemplary embodiment for saving a NETLIST and shape sections to memory for utilization in a semiconductor device simulation, according to embodiments of the invention.

FIG. 7 illustrates an exemplary embodiment of simulating a semiconductor device to determine transistor model quantities utilizing a NETLIST and shape sections, according to embodiments of the invention.

FIG. 8 illustrates an exemplary embodiment of utilizing transistor model quantities to optimize circuit designs, according to embodiments of the invention.

FIG. 9 illustrates an exemplary computer that simulates a semiconductor device to determine transistor model quantities utilizing a NETLIST and shape sections, according to embodiments of the invention.

### DETAILED DESCRIPTION

Embodiments of the present invention extend previously developed layout-sensitive compact model techniques to accurately account for effects of layout-induced changes in semiconductor devices. In particular, the invention accounts for the impact of large layout and/or sensitive variations on circuits with techniques for obtaining LDE response approximations and layout extraction algorithms to obtain the correct geometric parameters that drive the LDE response. Particularly, these techniques include specific “shape sections” information that are directionally-oriented and include directionally-specific distance measurements for analyzing in detail the associated shape neighborhood of the semiconductor device.

It is problematic to interpolate experimentally-based results for possible physical semiconductor devices because the physical layout variations are numerous and typical layout rules are either too complex or too general to predict with such variations. Therefore, the experimental data cannot encompass all possible variations, and there will be many situations where extrapolation well beyond the data range with a predictive methodology is needed.

For example, LDE function, or response, for such a semiconductor device is complex, three-dimensional, and is sensitive to the layout of the semiconductor device. Therefore, circuit simulation with layout-dependent LDE effects on the FET would incorporate TCAD (Technology Computed-Aided Design) simulation. However, it may not be possible to perform a full 3D calculation of layout dependent effects for each layout variation because of the high cost in CPU time. Further, with a nearly infinite number of layout variations and with each individual 3D finite element model (FEM) stress and/or LDE calculation taking hours of CPU runtime, the problem of determining LDE transistor model quantities is intractable. Even performing 2D calculations linked to the circuit simulators is difficult. Thus, embodiments of the invention address these issues by providing techniques to approximate such complexities to accurately account for effects of layout-induced changes in semiconductor devices.

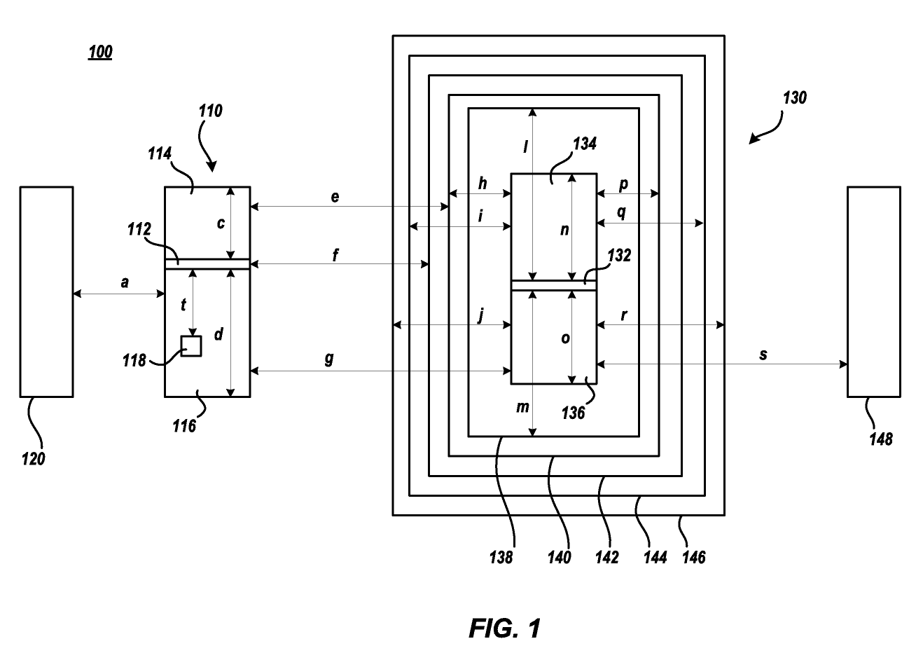

FIG. 1 illustrates an example of a semiconductor device 100 that may be simulated to determine transistor model quantities and illustrates how the layout of the semiconductor device 100 affects the transistor model quantities. Semiconductor device 100 includes multiple FET devices, such as nFET 110 and pFET 130. nFET 110 may include numerous gates, though a particular gate 112 is shown. nFET 110 further includes a source region 114 and drain region 116 shown on the north side and south sides of the gate 112, respectively. Likewise, pFET 130 may include numerous gates, though a particular gate 132 is shown. pFET 130 further includes a source region 134 and drain region 136 shown on the north side and south sides of the gate 132, respectively. Each source region and drain region may include a respective conductive contact electrically contacting the associated region, though only a particular contact 118 is shown associated with drain region 116.

Semiconductor device may further include diffusion region 120, diffusion region 148, N-well stress liner film region 138, N-well region 140, PG gate region 142, PH well implant region 144, BN well implant region 146.

The relative shape and position of the region(s) and other FET devices affect transistor operating values, such as device mobility, work function, series resistance, saturation velocity, etc. In other words, the physical layout of the various regions and the various FET devices affect how each FET operates. In embodiments, previously known layout-dependent effects such as N-well scattering in addition to engineered layout-dependent effects such as liner film stress may be analyzed.

In particular, the distance “a” from the diffusion region 120 and nFET 110 alters STI stress of nFET 110. Further, the distance “c” between gate 112 and the end of source region 114 and the distance “d” between gate 112 and the end of drain region 116 alters STI stress of nFET 110. The distance “t” from the gate 112 and contact 118 alters tensile stress through an associated stress liner film of nFET 110.

Generally, the distance between transistors may also affect transistor performance. For example, the distance “e” from nFET 110 to N-well region 140 can alter doping scattering and thus the threshold voltage of nFET 110, the distance “f” from nFET 110 to PG gate region 142 alters the threshold voltage of nFET 110, and the distance “g” between nFET 110 and pFET 130 alters multiple layout-dependent effects in nFET 110 and pFET 130.

Similar to above, the distance “s” from diffusion region 148 and pFET 130 alters STI stress of pFET 130. Further, the distance “n” between gate 132 and the end of source region 134 and the distance “o” between gate 132 and the end of drain region 136 alters STI stress pFET 130. The distance “1” between gate 132 and the north border of N-well stress liner film region 138 and the distance “m” between gate 132 and the south border of N-well stress liner film region 138 alters the compressive/tensile liner film interface of pFET 130. The distances “j” and “r” between pFET 130 and the west and east boarders of BN well implant region 146, respectively, alters the threshold voltage pFET 130. The distance “i” and “q” between pFET 130 and the west and east boarders of PH well implant region 144, respectively, alters threshold voltage of pFET 130. The distance “h” and “p” between pFET 130 and the west and east boarders of N-well region 140, respectively, alters N-well scattering of pFET 130.

In addition to region shape and dimensional influences upon transistor devices, the number of adjacent device structures associated with the transistors may also affect transistor performance. For example, the spacing between contacts, the number of contacts, the contact material density, and relative shape of contacts may alter transistor performance. Likewise, the number of gates, the spacing between gates, the shape of gates, and the like also affect transistor performance.

In general, the presence of adjacent regions tends to degrade the liner film stress seen by the transistor gate and therefore reduces performance. An example is a local contact 118 shape adjacent to the gate 112. Generally the stress decreases as the contact 118 shape is positioned closer to the gate 112. The stress due to stressed liner films increases as the contact 118 strapping factor is decreased because of the smaller interruption of the liner film. However these changes affect other aspects of the electrical response of the transistor. For example, moving the contact 118 shape closer to the gate 112 increases capacitive coupling with the gate 112, which is generally a negative factor, and reducing the strapping factor increases the effective series resistance of the transistor, which is also a negative factor. Other factors such as adjacent gates can also influence the liner film stress response. For example, close gates tends to improve transistor performance but reduce the effect of engineered stress due to liner films. Adjacent poly wiring may reduce wiring resistance but also reduce stress. Therefore, since there are design tradeoffs between stress and/or LDEs and other circuit electrical factors, it is desirable to use the LDE-enabled compact model to optimize the circuit response.

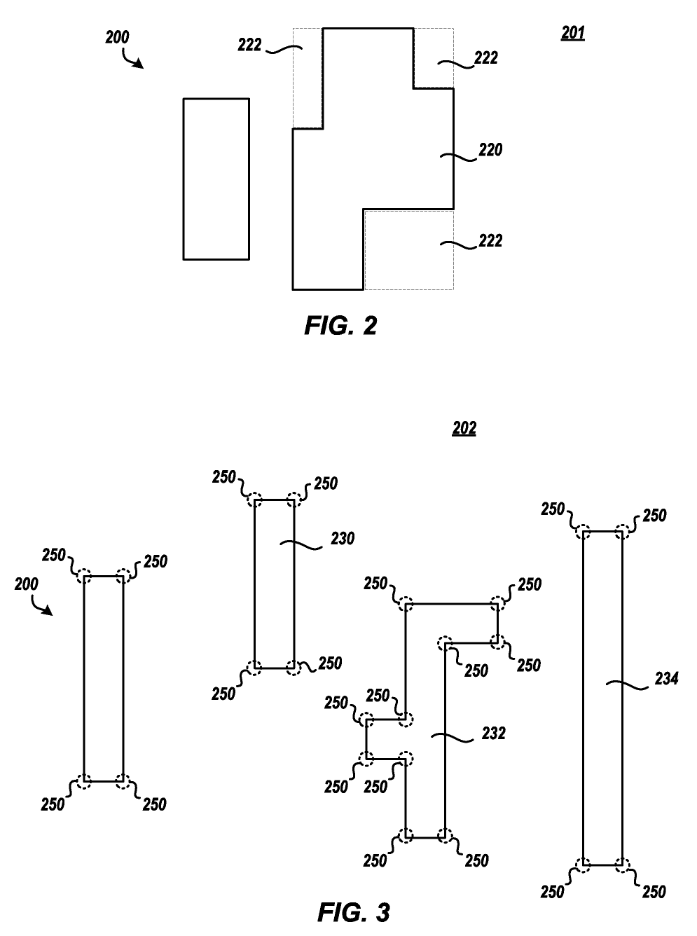

FIG. 2 illustrates an example of a semiconductor device 201 that may be simulated to determine transistor model quantities and illustrates how the layout of the semiconductor device 201 affects the complexity of the simulation. Semiconductor device 201 includes a device 200 (e.g. transistor, gate, etc.) and region 220 (e.g. source region, drain region, diffusion region, N-well stress liner film region (in this exemplary process the N-well defines both the stress liner interface and the N-well implant mask), N-well region, PG gate layer region, PH well implant region, BN well implant region, etc.) adjacent thereto that affects the performance of the device 200. Region 220 includes notches 222 or serrations that give region 220 an irregular shape. Such region 220 irregularity increases the difficultly in determining device 200 operating values when simulating semiconductor device 201. In the context of this document, the term “shape” is defined as the profile of a respective device, region, etc.

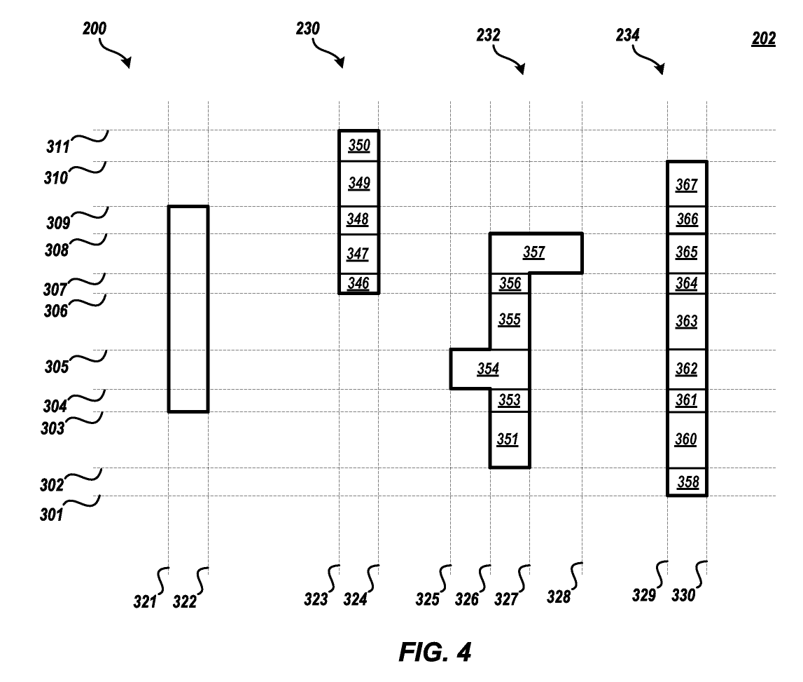

FIG. 3 illustrates a semiconductor device section shape definition stage, according to embodiments of the invention. The section shape definition process may be associated with a netlist generation stage of a circuit simulation. At the present section shape definition stage, a circuit layout of a semiconductor device 202, such as a netlist, is generated and shape vertices 250 are defined. An exemplary circuit layout, as is depicted in FIG. 3, includes device 200 and shapes 230, 232, and 234. Shapes 230, 232, 234 may be the shape of an associated region such as the shape of a source region, drain region, diffusion region, N-well stress liner film region, N-well region, PG gate region, PH well implant region, BN well implant region, etc.

Though the shapes 230, 232, 234 are shown east of device 200, the shapes 230, 232, 234, or additional shapes, may be located west, north, and/or south of device 200. The vertices 250 of each shape may be determined by raster scanning the circuit layout to determine shape edges and defining the vertices 250 at locations where shape edges intersect. For example, vertices 250 of device 200 and shape 230, shape 232, and shape 234 are defined at the intersections of neighboring lines of the device 200 and each shape 230, 232, 234.

FIG. 4 illustrates a semiconductor device section shape definition stage, according to embodiments of the invention. At the present section shape definition stage, reference lines are rendered at each of the vertices 250 and shape sections are defined. A reference line serves as a basis for comparison or measurement. Reference line 301 is rendered at the southern vertices 250 of shape 234. Reference line 302 is rendered at the southern vertices 250 of shape 232. Reference line 303 is rendered at the southern vertices 250 of device 200. Reference line 304 and reference line 305 are rendered at the irregular vertices 250 of shape 232, respectively. Reference line 306 is rendered at the southern vertices 250 of shape 230. Reference line 307 and reference line 308 are rendered at the irregular vertices 250 of shape 232, respectively. Reference line 309 is rendered at the northern vertices 250 of device 200. Reference line 310 is rendered at the northern vertices 250 of shape 234. Likewise, reference line 311 is rendered at the northern vertices 250 of shape 230.

In an embodiment, reference lines are rendered in a particular direction from device 200 toward respective shapes. For example, reference lines may be rendered eastward from device 200 when shapes are east of device 200, rendered westward from device 200 when shapes are west of device 200, rendered northwardly from device 200 when shapes are north of device 200, and rendered southward from device 200 when shapes are south of device 200. In this embodiment, shape sections are defined by the intersections of the respective shape perimeter and the reference lines traversing the shape. For example, shape sections 346, 347, 348, 349, and 350 are defined within shape 230, shape sections 351, 353, 354, 355, 356, and 357 are defined within shape 232, and shape sections 358, 360, 361, 362, 363, 364, 365, 366, and 367 are defined within shape 234.

Shape section 346 is defined as the intersection of the western and eastern edges of shape 230 and reference lines 306 and 307. Shape section 347 is defined as the intersection of the western and eastern edges of shape 230 and reference lines 307 and 308. Shape section 348 is defined as the intersection of the western and eastern edges of shape 230 and reference lines 308 and 309. Shape section 349 is defined as the intersection of the western and eastern edges of shape 230 and reference lines 309 and 310. Likewise, shape section 350 is defined as the intersection of the western and eastern edges of shape 230 and reference lines 310 and 311.

Shape section 351 is defined as the intersection of the intermediate western and intermediate eastern edges of shape 232 and reference lines 302 and 303. Shape section 353 is defined as the intersection of the intermediate western and intermediate eastern edges of shape 232 and reference lines 303 and 304. Shape section 354 is defined as the intersection of the western and intermediate eastern edges of shape 232 and reference lines 304 and 305. Shape section 355 is defined as the intersection of the intermediate western and intermediate eastern edges of shape 232 and reference lines 305 and 306. Shape section 356 is defined as the intersection of the intermediate western and intermediate eastern edges of shape 232 and reference lines 306 and 307. Likewise, shape section 357 is defined as the intersection of the intermediate western and eastern edges of shape 232 and reference lines 307 and 308.

Shape section 358 is defined as the intersection of the western and eastern edges of shape 234 and reference lines 301 and 302. Shape section 360 is defined as the intersection of the western and eastern edges of shape 234 and reference lines 302 and 303. Shape section 361 is defined as the intersection of the western and eastern edges of shape 234 and reference lines 303 and 304. Shape section 362 is defined as the intersection of the western and eastern edges of shape 234 and reference lines 304 and 305. Shape section 363 is defined as the intersection of the western and eastern edges of shape 234 and reference lines 305 and 306. Shape section 364 is defined as the intersection of the western and eastern edges of shape 234 and reference lines 306 and 307. Shape section 365 is defined as the intersection of the western and eastern edges of shape 234 and reference lines 307 and 308. Shape section 366 is defined as the intersection of the western and eastern edges of shape 234 and reference lines 308 and 309. Likewise, shape section 367 is defined as the intersection of the western and eastern edges of shape 234 and reference lines 309 and 310.

In another embodiment, first reference lines are rendered in a particular direction from device 200 toward respective shapes and second reference lines may be rendered in an orthogonal direction. For example, reference lines (e.g. 301-311) are rendered in the east direction and reference lines (e.g. 321-330) may be rendered in an orthogonal direction. Reference line 321 and reference line 322 are rendered at the western and eastern vertices of device 200, respectively. Reference line 323 and reference line 324 are rendered at the western and eastern vertices of shape 230, respectively. Reference line 325, reference line 326, reference line 327, and reference line 328 are rendered at the western, eastern, and irregular vertices of shape 232, respectively. Reference line 329 and reference line 330 are rendered at the western and eastern vertices of device 200, respectively. The above process may be repeated upon shapes that exist west, north, and south of device 200.

In this embodiment, shape sections are defined by the intersections of the reference lines. As such, shape section 346 is defined as the intersection of reference lines 323, 324, 306 and 307. Shape section 347 is defined as the intersection of reference lines 323, 324, 307 and 308. Shape section 348 is defined as the intersection of reference lines 323, 324, 308 and 309. Shape section 349 is defined as the intersection of reference lines 323, 324, 309 and 310. Likewise, shape section 350 is defined as the intersection of reference lines 323, 324, 310 and 311.

Shape section 351 is defined as the intersection of reference lines 326, 327, 302 and 303. Shape section 353 is defined as the intersection of reference lines 326, 327, 303 and 304. Shape section 354 is defined as the intersection of reference lines 325, 327, 304 and 305. Shape section 355 is defined as the intersection of reference lines 326, 327, 305 and 306. Shape section 356 is defined as the intersection of reference lines 326, 327, 306 and 307. Likewise, shape section 357 is defined as the intersection of reference lines 326, 328, 307 and 308.

Shape section 358 is defined as the intersection of reference lines 329, 330, 301 and 302. Shape section 360 is defined as the intersection of reference lines 329, 330, 302 and 303. Shape section 361 is defined as the intersection of reference lines 329, 330, 303 and 304. Shape section 362 is defined as the intersection of reference lines 329, 330, 304 and 305. Shape section 363 is defined as the intersection of reference lines 329, 330, 305 and 306. Shape section 364 is defined as the intersection of reference lines 329, 330, 306 and 307. Shape section 365 is defined as the intersection of reference lines 329, 330, 307 and 308. Shape section 366 is defined as the intersection of reference lines 329, 330, 308 and 309. Likewise, shape section 367 is defined as the intersection reference lines 329, 330, 309 and 310.

The shape section definitions may be saved within the netlist or otherwise associated with the netlist to be utilized in subsequent layout dependent circuit simulations.

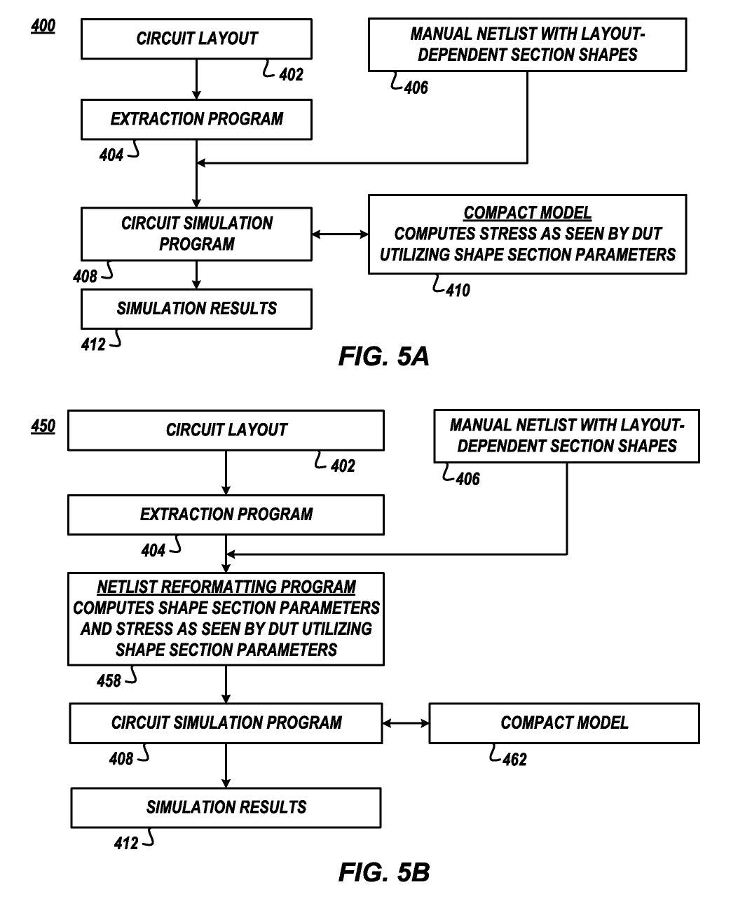

FIG. 5A illustrates a layout extraction process 400 utilized to calculate simulated semiconductor device transist or model quantities, according to one embodiment of the invention. At block 402, circuit layout data is provided, e.g., in a GL1 or GDSII format. GL1 (Graphics Language 1, developed by IBM Corporation) and GDSII (Graphic Data System version 2, developed by GE CALMA) which refer to graphics languages that provide a standard file format for transferring and archiving 2D graphical design data.

According to a first phase of the circuit simulation, an extraction program 404 is executed to provide a netlist annotated with shape parameters including, for example shape vertex locations (i.e. x, y coordinates of each vertex), section height, the distance of each segment from an edge of the gate, etc. One example extraction program is the Efficient Rapid Integrated Extraction (ERIE) parasitic model extraction tool from IBM Corporation, that typically provides circuit-level netlists from layout design data, and extracts interconnect resistance and capacitance. Other examples of extraction tools include the Calibre tool, available from Mentor Graphics Corp, San Jose, Calif., and the IC Validator (ICV) tool, available from Synopsys, Inc., Mountain View, Calif. Thus, in the first phase of the algorithm, the extraction tool provides layout-dependent information including non-specific shape information.

According to a second phase of circuit simulation, a compact model 410 that is augmented with LDE algorithms is executed. Compact model 410 computes LDE effects as seen by a device under test (DUT) that are associated with associated respective shape sections. The DUT may also be referred herein as a reference region. According to a third phase of the circuit simulation, compact model 410 additionally computes other layout specific transistor model quantities, such as device mobility quantities, work function quantities, series resistance quantities, saturation velocity quantities, or the like that are associated with respective shape definitions. The compact model 410 may be a standard BSIM model that is compatible with a circuit simulator such as PowerSPICE, developed by IBM Corporation, Hspice, available from Synopsys, Inc., San Jose, Calif., or the Cadence Spectre Circuit Simulator, available from Cadence Design Systems, Inc., San Jose, Calif. BSIM or more specifically, “BSIMSOI” refers to compact model code for Silicon-on-insulator (SOI) devices that is publicly available from the University of California, Berkeley. “SOI” here denotes “partially-depleted silicon-on-insulator”, but note that the subject matter disclosed herein is not limited to a specific compact model type.

Thus, according to the second phase of the circuit simulation, the annotated netlist interface comprising layout-dependent information including non-specific shape definition information (i.e., raw section data) obtained from the extraction tool is converted into specific shape definition information (i.e., edge-to-edge distances, edge lengths, etc.).

It should be understood that, in one embodiment, the annotated netlist information provided by the extraction program may first be compressed into a standard format (an “interface”) and that compressed layout description is passed to the compact model 410. This may be needed due to limitations in the way information is passed between the two programs (extractor 404 and compact model 410). Alternatively, the layout information may be passed from the extraction program 404 to the compact model 410 without compression. For example, if there was a software environment in which these two codes (layout extraction and layout-dependent compact model) were tightly coupled, the extractor 404 could directly pass all of the shape section definition information verbatim to the compact model 410. One implementation for this method of passing data is a linked list of shape section coordinates.

More particularly, according to the second phase circuit simulation, there is an initial step defining shape sections by determining shape vertices and rendering of reference lines. By considering each shape section, the information about the number of shape sections and their physical width and length, where width is stored as the location of starting/ending edges of the shape section and length (i.e., “runlength”) is defined to be parallel to the edge of the DUT. Note that the runlength is the same for all edges of a given shape that are defined by two adjacent reference lines. The result of the second phase circuit simulation is a list of layout information concerning shape sections relative to the DUT. This is done for west, east, north, and south sides of the DUT using the associated gate shape as a center reference.

The third phase circuit simulation implements the LDE compact model code which translates the raw LDE shape segment data into compact model parameters which are utilized by transistor compact model equations and by the circuit simulation program 408 for circuit simulation. This phase considers both longitudinal LDEs (along the direction of current flow in an FET) and transverse LDEs (parallel to the DUT gate) associated with the various shape sections. Analytic expressions are used to make this conversion. The compact model parameters can include terms such as FET mobility. The compact model parameters are then passed to the compact model code such as the above-referenced BSIM model.

As further shown in FIG. 5A, the circuit simulation program 408 may also receive manually-created netlist input 406 which includes shape section definitions. Generally, compact models for circuit simulation are CAD tools for circuit design that play an important role in designing nanometer scale systems-on-chip (SOC). In particular, a compact model plays a key role in the accuracy and efficiency of the circuit simulator used by designers, as well as a bridge to the technology in which the design is to be fabricated. Compact models for circuit simulation element such as field-effect transistors include effects such as geometry, bias, temperature, DC, AC, RF, and noise characteristics.

Finally, as shown in FIG. 5A, the circuit simulation program 408 is executed utilizing the compact model parameters to analyze the electrical performance of various circuit topologies, and simulation results 412 are generated.

FIG. 5B illustrates an alternative embodiment of layout extraction algorithm according to the invention. In the embodiment depicted in FIG. 5B, it is noted that while the LDE algorithm may be invoked as part of the compact model that are used in circuit simulation, it can also be incorporated in a software application 458 that functions independently of the compact model 462 (with no LDE algorithm) and the circuit simulator 408 for the purpose of simplifying extracted netlists that include LDE instance parameters. In this latter application, an extracted netlist with all layout-dependent effect parameters and with section shape definition included is input to the program 458 that calls the LDE algorithm. The LDE algorithm then computes transistor model parameters (such as mobility) that are needed during circuit simulation and generates a netlist that includes the computed transistor model parameters. The program 458 for netlist reformatting could be a separate program, part of the extraction program 404, or part of the circuit simulator 408, etc.

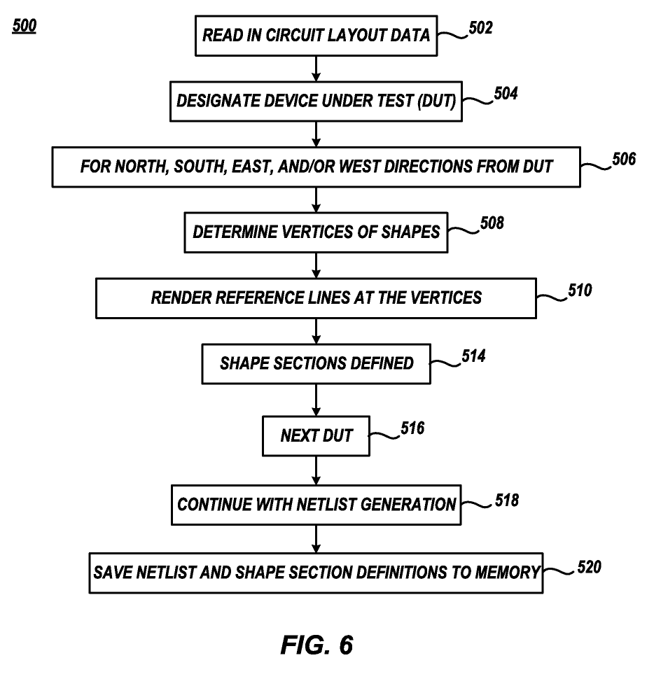

FIG. 6 illustrates the methodology 500 implemented by netlist extraction program for LDE analysis 404, shown in FIG. 5A. As shown in FIG. 6, at block 502 two dimensional graphical layout data for the circuit is read. The following process is iteratively performed: for each device (block 504), such as a transistor gate included in the circuit, and, for each of north, south, east, and west directions from the device (block 506) shape vertices are located (block 508), reference lines are rendered at each of the shape vertices (block 510), and shape sections are defined (block 514). Shape sections may be defined, in a first technique, as the intersections of the shape perimeter and adjacent reference lines traversing the shape at vertices or, in a second technique, as the intersections of reference lines rendered upon the shape edges and adjacent reference lines traversing the shape. A next device is determined (block 516) and the above process repeats. The netlist extraction program 404 incorporates layout-dependent information into individual transistor instances into the netlist definition as is known in the art (block 518) and the netlist is saved in memory. The netlist may be embedded with shape section definitions or the shape section definitions may be saved in a separate instance within memory, relative to the netlist (block 520). For example, the netlist may be save in a first file and the shape section definitions may be saved in a second file within the same memory, the netlist may be saved in a first memory and the shape section definitions may be saved in a second memory, etc. Upon the existence of shape section definitions saved in memory the operation of the data handling system evoking the compact model changes to determine transistor model quantities at a shape section granularity as opposed to determining transistor model quantities at whole shape granularity.

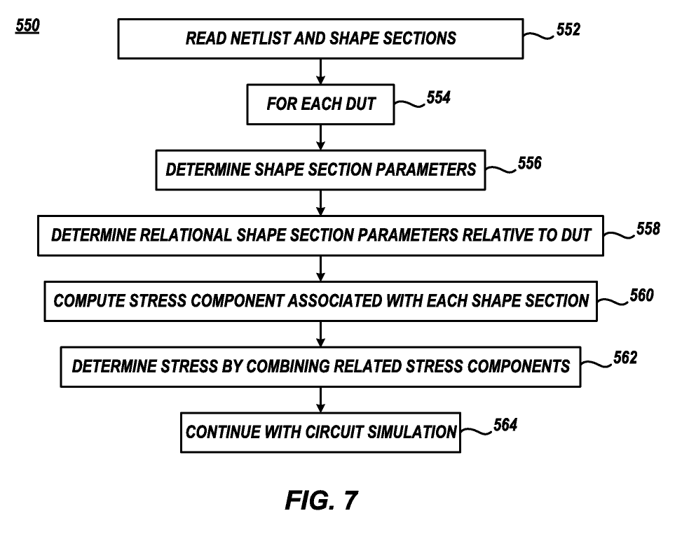

Referring now to FIG. 7, there is a flow chart depicting the methodology 550 used in compact model/circuit simulation according to embodiments of invention as performed by the compact modeling program 410 as shown in FIG. 5A. For each DUT (block 554) processing steps to be performed pertain to each FET to be modeled. At block 552 there is depicted the step of reading the netlist and section shape definitions provided by extraction program 404. The next step 556 involves scanning the relevant netlist information and shape section definition (e.g., vertex x and y coordinates, etc.) for each of the included shapes associated with the DUT. From the netlist information obtained at step 556, the next step 558 involves computing the size and position of the shape sections associated with the device in relation to the DUT, or if section coordinates are available, this information is available inherently. The relational shape section parameters relative to the DUT may be complied in a list of shape section sizes, positions, and distances, relative to the DUT. In a particular embodiment, the shape section parameters may be shape section vertex coordinates. In another embodiment, the shape section parameters may be the shape section height and width.

From this information, the LDE components associated with each shape section as seen by the DUT are computed (block 560) and like LDE components may be combined (block 562). For example, LDE components of each shape may be combined to determine the overall LDE associated with entire shapes as seen by the DUT. Likewise, LDE components of shape sections sharing reference lines may be combined to determine a LDE as seen by the DUT portion also sharing the reference lines. For example, referring to FIG. 4, respective LDE components of shape section 354 and shape section 362 may be combined to determine a LDE as seen by the DUT portion defined by reference lines 304, 305, 321, and 322.

The process may be repeated for a next DUT within the circuit, and the compact modeling program continues with the regular circuit simulations (block 564) only now utilizing more accurate modeling as provided by the shape section techniques described herein. In the regular circuit simulations, circuit-level quantities may be computed from the shape section definitions or the transistor modeling parameters calculated utilizing the shape section definitions. That is, the compact model code to accomplish the regular circuit simulations can be a conventional code that is readily available from academia (such as a BSIM model) or a custom code that has been developed for circuit modeling. It should be understood that the shape section methodology is capable of handling semiconductor devices having more complex shapes than the common FET device arrangements.

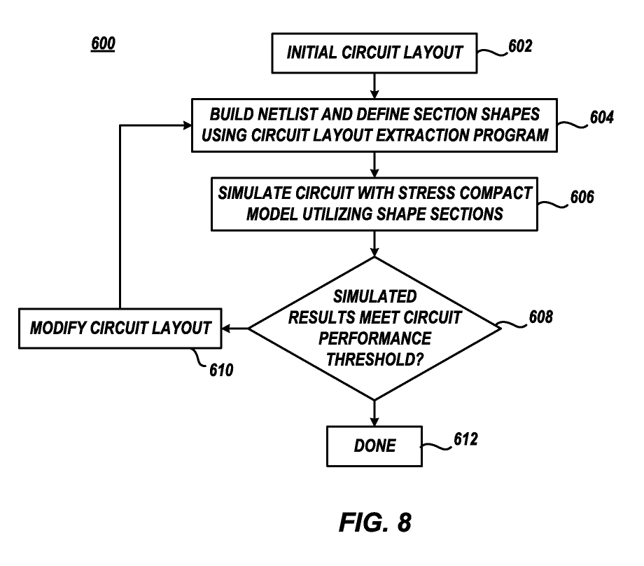

FIG. 8 illustrates an exemplary embodiment of utilizing transistor model quantities to optimize circuit designs, according to embodiments of the invention. A process 600 consists of an iterative loop between circuit layout, extraction, the compact model, and circuit simulation. Process 600 may be a part of an integrated circuit layout verification processes. During circuit layout verification, the interaction of the many chemical, thermal, and photographic regions are known and the behavior of the final integrated circuit depends largely on the positions and interconnections of the various region shapes. Using a computer-aided layout tool, the layout engineer may place and connect the components that make up the chip to generate a circuit layout which may be verified.

In a first step 602, there is depicted the step of providing the initial circuit layout, including, for example, reading in graphical layout data of devices in the circuit. Then, at a step 604, a netlist is built using the LDE-enabled layout extraction program 404. Continuing next to step 606, there is depicted the step of simulating the designed circuit using the LDE-enabled compact model that calculates an LDE as seen by the DUT utilizing shape sections. The next step 608 involves determining whether the circuit performance goals have been achieved for that particular design. If the performance goals have been met, then the process terminates at step 612; otherwise, if the designed circuit did not meet those performance goals, the circuit design may be modified as indicated at step 610 and the process returns to step 604 in order to build a new netlist and shape definitions using the layout extraction program 404.

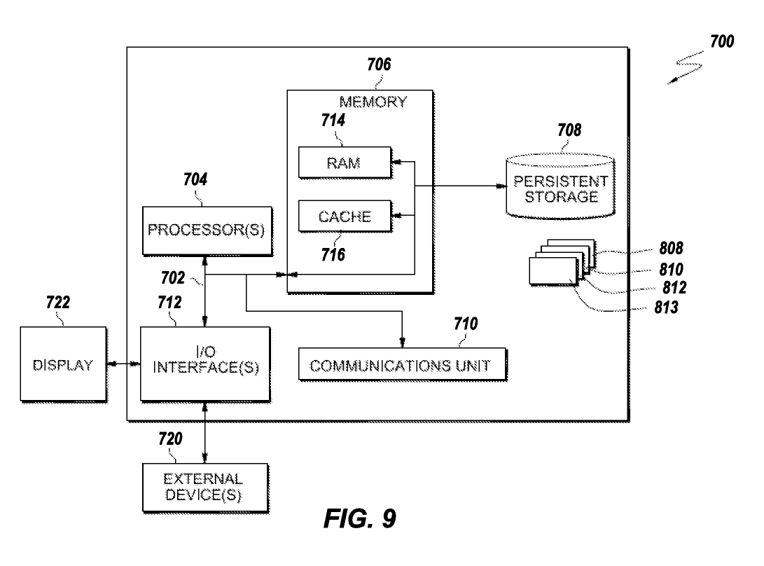

FIG. 9 illustrates an exemplary computer 700 that simulates a semiconductor device to determine transistor model quantities utilizing a netlist and shape section definitions, according to embodiments of the invention.

Computer 700 include one or more processors 704, one or more computer-readable memories 706 which may include a RAM memory 714 and or one or more cache memories 716. Computer 700 may further include one or more buses 702, one or more operating systems 808, and one or more computer-readable tangible storage devices, such as persistent storage 708. The one or more operating systems 808, extraction program 404, compact model 410 or 462, and/or circuit simulator 408, may be stored on one or more of the respective computer-readable tangible storage devices for execution by one or more of the respective processors 704 via memory 706. In the illustrated embodiment, each of the computer-readable tangible storage devices is a magnetic disk storage device of an internal hard drive. Alternatively, each of the computer-readable tangible storage devices may be a semiconductor storage device such as read only memory, EPROM, flash memory or any other computer-readable tangible storage device that can store a computer program.

Computer 700 may also include a R/W drive or interface 712 to read from and write to one or more portable computer-readable tangible storage devices 720 such as a CD-ROM, DVD, memory stick, magnetic tape, magnetic disk, optical disk or semiconductor storage device. Extraction program 404, compact model 410 or 462, and/or circuit simulator 408 can be stored on one or more of the respective portable computer-readable tangible storage devices 720, read via the respective R/W drive or interface 712.

Computer 700 may also include a network adapter or interface 710 such as a TCP/IP adapter card. From the network adapter or interface 710, the programs are loaded into a computer readable storage medium. The network may comprise copper wires, optical fibers, wireless transmission, routers, firewalls, switches, gateway computers and/or edge servers. Computer 700 may also include a computer display monitor 722, a keyboard, a computer mouse, or other I/O device. Each of the sets of internal components of computer 700 may further include appropriate device driver programs to interface to other computer 700 components.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over those found in the marketplace, or to enable others of ordinary skill in the art to understand the embodiments disclosed herein.

What is claimed is:

1. A method of compact modeling of a semiconductor device, the semiconductor device comprising a region causing layout dependent effects upon the semiconductor device, the method comprising:
analyzing, with a processor, a circuit layout to determine a shape of the region;
defining, with the processor, shape sections within the shape;
determining, with the processor, layout dependent effects caused by each shape section upon the semiconductor device, and;
modeling, with the processor, semiconductor device performance based upon the layout dependent effects caused by each shape section.

2. The method of claim 1, wherein analyzing the circuit layout to determine the shape of the region further comprises:
extracting circuit layout dependent parameters determined from the shape of the region.

3. The method of claim 2, wherein defining shape sections within the shape further comprises:
locating vertices of the semiconductor device, and;
locating vertices of the shape.

4. The method of claim 3, wherein defining shape sections within the shape further comprises:
rendering first reference lines orthogonal to the semiconductor device at the vertices, wherein at least one first reference line traverses the shape.

5. The method of claim 4, wherein defining shape sections within the shape further comprises:
defining each shape section as the intersection of the shape perimeter and adjacent first reference lines, respectively.

6. The method of claim 4, wherein defining shape sections within the shape further comprises:
rendering second reference lines parallel to the semiconductor transistor device at the vertices.

7. The method of claim 6, wherein defining shape sections within the shape further comprises:
defining each shape section as the intersection of adjacent first reference lines and adjacent second reference lines, respectively.

8. The method of claim 3, wherein determining layout dependent effects caused by each shape section upon the semiconductor device further comprises:
determining distances from the semiconductor device to each shape section.

9. The method of claim 1, further comprising:
writing, with the processor, the shape section definitions to memory as a list of shape section vertex coordinates.

10. A computer program product for modeling a semiconductor device, the computer program product comprising a computer readable storage medium having program instructions embodied therewith, the program instructions readable by a processor to cause the processor to:
analyze a circuit layout to determine a shape of a region that causes layout dependent effects upon the semiconductor device;
define shape sections within the shape;
determine layout dependent effects caused by each shape section upon the semiconductor device, and;
model semiconductor device performance based upon the layout dependent effects caused by each shape section.

11. The computer program product of claim 10, wherein the program instructions which cause the processor to load the circuit layout to determine the shape of the region further cause the processor to:
extract circuit layout dependent parameters determined from the shape of the region.

12. The computer program product of claim 11, wherein the program instructions which cause the processor to define shape sections within the shape further cause the processor to:
locate vertices of the semiconductor device, and;
locate vertices of the shape.

13. The computer program product of claim 12, wherein the program instructions which cause the processor to define shape sections within the shape further cause the processor to:
render first reference lines orthogonal to the semiconductor device at the vertices, wherein at least one first reference line traverses the shape.

14. The computer program product of claim 13, wherein the program instructions which cause the processor to define shape sections within the shape further cause the processor to:
define each shape section as the intersection of the shape perimeter and adjacent first reference lines, respectively.

15. The computer program product of claim 13, wherein the program instructions which cause the processor to define shape sections within the shape further cause the processor to:
render second reference lines parallel to the semiconductor device at the vertices.

16. The computer program product of claim 15, wherein the program instructions which cause the processor to define shape sections within the shape further cause the processor to:
define each shape section as the intersection of adjacent first reference lines and adjacent second reference lines, respectively.

17. The computer program product of claim 11, wherein the program instructions which cause the processor to determine layout dependent effects caused by each shape section upon the semiconductor device further cause the processor to:
determine distances from the semiconductor device to each shape section.

18. The computer program product of claim 10, wherein the program instructions further cause the processor to:
write the shape section definitions to memory as a list of shape section vertex coordinates.

19. A method for optimizing semiconductor transistor performance comprising:
receiving, with a processor, a circuit layout comprising a semiconductor device and a region that causes layout dependent effects upon the semiconductor device;
analyzing, with the processor, the circuit layout to determine a shape of the region that causes layout dependent effects upon the semiconductor device and a shape of the semiconductor device;
locating, with the processor, vertices of the semiconductor device shape and vertices of the region that causes layout dependent effects;
defining, with the processor, sections of the shape of the region that causes layout dependent effects by rendering reference lines at the vertices of the semiconductor device shape and rendering reference lines at the vertices of the shape of the region that causes layout dependent effects;
determining, with the processor, layout dependent effects caused by each shape section upon the semiconductor device, and;
simulating, with the processor, semiconductor device performance based upon the layout dependent effects caused by each shape section, and;
modifying, with the processor, the circuit layout if the semiconductor device does not exceed a predetermined performance threshold.

20. The method of claim 19, wherein at least one reference line traverses the shape of the region that causes layout dependent effects.
